(19) United States
(12) Patent Application Publication
(10) Pub. No.: US 2016/0074261 A1
(43) Pub. Date: Mar. 17, 2016

(54) VEHICLE WHEELCHAIR LIFT

(71) Applicant: Mobility SVM, LLC, Fort Wayne, IN (US)

(72) Inventors: Richard J. Schoenian, Kokomo, IN (US); John R. McAfee, Bluffton, IN (US)

(21) Appl. No.: 14/487,913

(22) Filed: Sep. 16, 2014

(51) Int. Cl. A61G 3/06; A61G 7/10

(52) U.S. Cl. CPC A61G 3/062; A61G 7/1019; A61G 7/1034; A61G 7/1046; A61G 7/1073

(57) ABSTRACT

A compact wheelchair lift mechanism utilizes a horizontal actuator to advance the vehicle doors outwardly away from the side of the vehicle together with a wheelchair user supported by a platform, and a vertical actuator which then lowers the platform with the wheelchair and user downwardly between the doors and vehicle. With the platform on the ground next to the vehicle, the user may then roll forward and away from the vehicle. The vehicle doors are also pivotably attached to the lift mechanism, such that a user may exit the vehicle by simply opening the vehicle door about its traditional door hinge, and therefore without powering the actuators. In this way, the wheel chair lift mechanism provides for safe and easy exit from the vehicle even if electrical power is lost, and facilitates use of the vehicle by both wheelchair-using drivers and drivers who do not use a wheelchair.

### BACKGROUND

1. Technical Field

The present disclosure relates to wheelchair lifts. More particularly, the present disclosure relates to wheelchair lifts for use with passenger vehicles, and to a method for using the same.

2. Brief Description of the Related Art

Many persons who use wheelchairs are licensed to operate motor vehicles. Generally, the operator and the wheelchair must enter and exit the vehicle with the assistance of a lift mechanism which lifts the vehicle operator and wheelchair from the ground and into the vehicle cabin. Once inside, the operator can maneuver into a driver's position. Existing wheelchair lift assemblies require extensive modification to the vehicle, and have parts which extend outside the vehicle, i.e., into the undercarriage area. These protruding parts significantly impact the aesthetics and ground clearance of the vehicle. Further, these traditional wheelchair lifts are not compatible with 4-wheel drive vehicles because they occupy space in the undercarriage normally reserved for 4-wheel drive systems such as transfer cases.

A wheelchair lift system compatible with four wheel drive and other vehicles is described in U.S. Patent Application Publication No. 2011/0070057, filed Sep. 22, 2010 and entitled “Vehicle Wheelchair Lift”, the entire disclosure of which is hereby expressly incorporated herein by reference for all that it teaches and for all purposes. In particular, the '057 disclosure describes a wheelchair lift system in which a lateral actuator moves a wheelchair support and the vehicle doors laterally outwardly from a vehicle cabin, and a vertical actuator then lowers the wheelchair support to the ground for egress of the vehicle occupant from the vehicle cabin.

The '057 disclosure uses doors which are permanently fused to the lateral actuator assembly, which in turn requires electrical (or possibly, hydraulic or pneumatic) power to drive the horizontal and vertical actuators between their extended and retracted positions. Therefore, a loss of power to the vehicle may complicate efforts to enter or exit the vehicle cabin. Moreover, because the vehicle doors adjacent the wheelchair lift are not manually operable, drivers of the '057 vehicle who do not use a wheelchair must also utilize the horizontal and vertical actuators for vehicle ingress and egress.

What is needed is an improvement over the foregoing.

### SUMMARY

The present disclosure provides a compact wheelchair lift mechanism which utilizes a horizontal actuator to advance the vehicle doors outwardly away from the side of the vehicle together with a wheelchair user supported by a platform, and a vertical actuator which then lowers the platform with the wheelchair and user downwardly between the doors and vehicle. With the platform on the ground next to the vehicle, the user may then roll forward and away from the vehicle. In addition to this actuator-based mode of entry and exit, the vehicle doors are also pivotably attached to the lift mechanism, such that a user may exit the vehicle by simply opening the vehicle door about its traditional door hinge, and therefore without powering the actuators. In this way, the wheel chair lift mechanism provides for safe and easy exit from the vehicle even if electrical power is lost, and facilitates use of the vehicle by both wheelchair-using drivers and drivers who do not use a wheelchair.

A number of additional features are provided which enhance convenience, safety and capacity, as described further below. These features include an actuator override switch which enables a user to allow actuation of the horizontal and vertical actuators regardless of the status and functionality of other safety switches, a high capacity lift mechanism which is adjustable to accommodate differing driver and wheelchair weights, robust actuator guide mechanisms which ensure smooth function of the horizontal and vertical actuators with a wide ranging array of wheelchair and user weights, and various door-alignment features which ensure a clean, factory-stock appearance of the vehicle when the doors are closed.

In one embodiment thereof, the present disclosure provides a wheelchair-accessible vehicle having a vehicle body including a floor, a passenger side and a driver side, a vehicle cabin accessible by an opening formed in at least one of the passenger and driver sides, the vehicle including a powered wheelchair lift system and the door assembly. The powered wheelchair lift system has a lateral actuator having a lateral actuator arm laterally extendable with respect to the vehicle body, the lateral actuator arm moveable between an extended position and a retracted position, a vertical actuator coupled to the lateral actuator arm, the vertical actuator having a vertical actuator arm vertically moveable between a raised position and a lowered position, and a wheelchair support coupled to the vertical actuator arm, the wheelchair support positioned inside the vehicle when the lateral actuator arm is in the retracted position and the vertical actuator arm is in the raised position. The wheelchair support is positioned outside the vehicle when the lateral actuator arm is in the extended position and the vertical actuator arm is in the lowered position. The door assembly includes a pillar assembly fixed to the lateral actuator arm and a door hinged to the pillar assembly and pivotable between an open position and a closed position. The pillar assembly and the door are laterally separable from the vehicle body when the lateral actuator is moved from the extended position to the retracted position. The door is manually pivotable between the open position and the closed position without actuation of the powered wheelchair lift system.

In another embodiment, the present disclosure provides a method of modifying a vehicle to include a wheelchair lift, the method including removing a front door from front-door hinges mounted at a front pillar of a vehicle body of the vehicle; removing a rear door from rear-door hinges mounted at a central pillar of the vehicle body; removing the central pillar from the vehicle body; mounting a lateral actuator inside the body, the lateral actuator positioned to extend laterally from the vehicle body; mounting a vertical actuator to the lateral actuator such that the vertical actuator is extendable from inside the vehicle body to outside the vehicle body; coupling the central pillar, front-door hinges and rear-door hinges to the lateral actuator; and coupling a wheelchair tray to the vertical actuator such that the wheelchair tray is moveable between a lowered position adjacent the ground and a raised position a floor of the vehicle.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a perspective view of a vehicle having a wheelchair lift in accordance with the present disclosure, illustrated with all doors closed;

FIG. 2 is a perspective view of the vehicle shown in FIG. 1, with front and rear lift-side doors manually opened;

FIG. 3 is a perspective view of the vehicle shown in FIG. 1, with the wheelchair lift illustrated in a lowered and extended position;

FIG. 4 is a partial perspective view of the vehicle shown in FIG. 3, illustrating a lowered floor of the vehicle and the horizontal actuator of the wheelchair lift;

FIG. 5 is a cross-section, elevation view of the horizontal actuator shown in FIG. 4, taken along the line V-V;

FIG. 6 is another perspective view of the vehicle shown in FIG. 3;

FIG. 7 is a partial, elevation view of the vehicle shown in FIG. 1, illustrating the support frame for the front and rear lift-side vehicle doors;

FIG. 8 is a perspective view of the lift-side vehicle doors and vertical actuator, taken from inside the vehicle cabin;

FIG. 9 is a perspective view of a vehicle door retention clamp in accordance with the present disclosure;

FIG. 10 is a perspective view of vehicle operation switches, including an override switch for the horizontal and vertical actuators of the wheelchair lift;

FIG. 11 is a perspective view of a platform pivot mechanism which provides a pivotal attachment between the vertical actuator of the wheelchair lift and the wheelchair support platform;

FIG. 12 is an elevation view of the wheelchair support platform shown in FIG. 11, shown lying flat on the ground;

FIG. 13 is another elevation view of the wheelchair support platform shown in FIG. 12, pivoted upwardly at the initiation of a vertical lift operation; and

FIG. 14 is a perspective view of a seat assembly compatible with the wheelchair lift of the present disclosure for use of the vehicle by a non-wheelchair user.

Corresponding reference characters indicate corresponding parts throughout the several views. The exemplification set out herein illustrates a preferred embodiment of the invention and such exemplification is not to be construed as limiting the scope of the invention in any manner.

### DETAILED DESCRIPTION

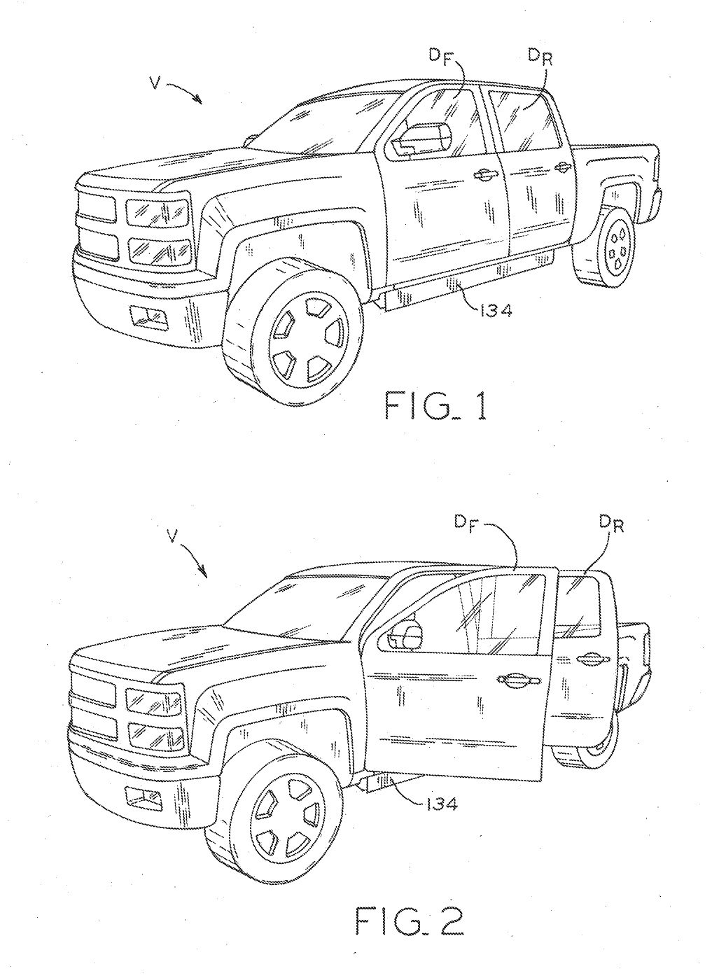

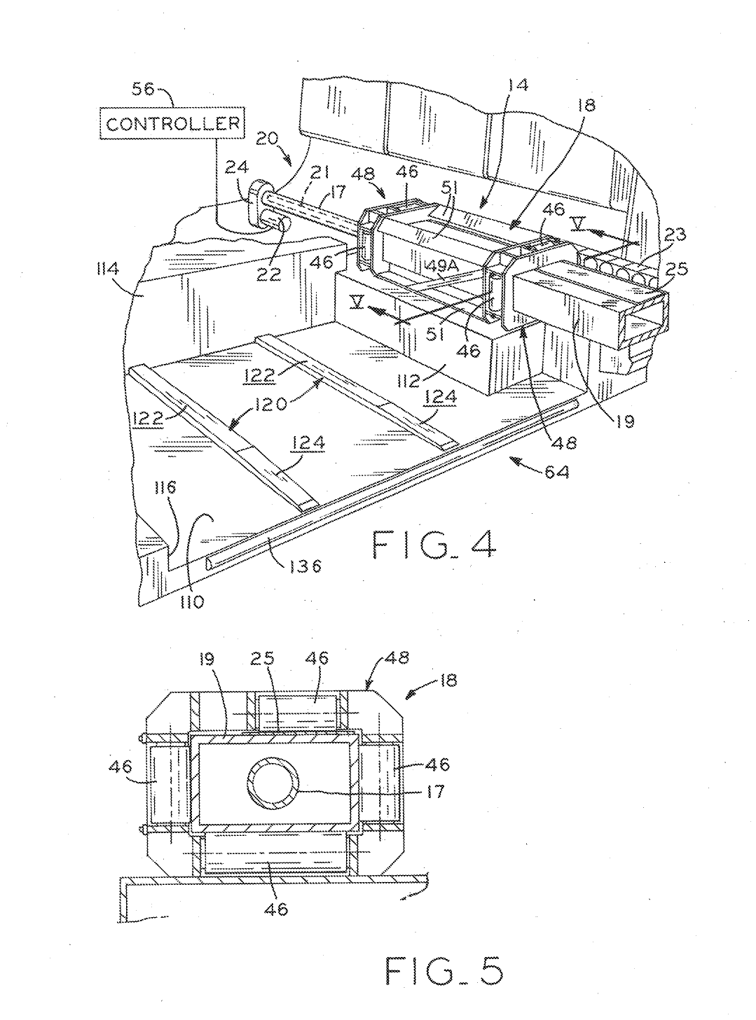

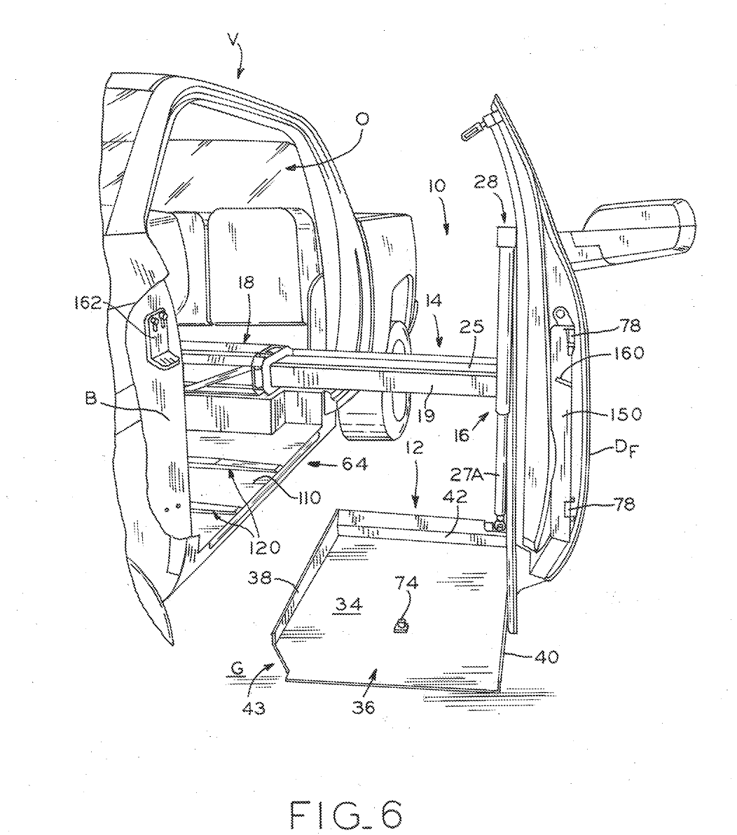

Referring generally to FIGS. 1-6, wheelchair lift 10 in accordance with an exemplary embodiment of the invention is provided for transporting a person in a wheelchair from a location on ground G at the side of vehicle V (FIGS. 4 and 6) to the inside of the cabin of vehicle V using powered actuators 14, 16 (FIG. 6), while also allowing a person to enter and exit the vehicle without a wheelchair by manual operation of vehicle door D_{F} and/or D_{R}. The combination of a manual entry/exit option with the powered wheelchair lift 10 facilitates easy transitioning between wheelchair users and non-wheelchair users. In addition, because manual operation of doors D_{F} and/or D_{R} does not require electrical power, non-wheelchair users can enter or exit the cabin of vehicle V, and wheelchair users can be safely removed from the cabin of vehicle V, without using electrical power.

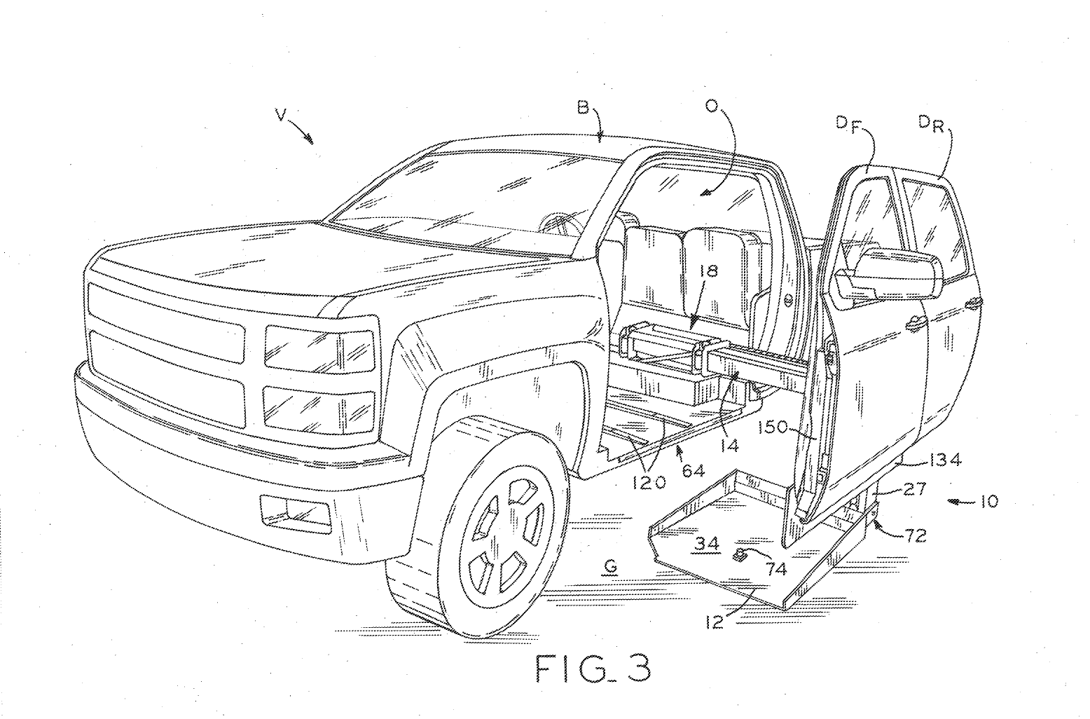

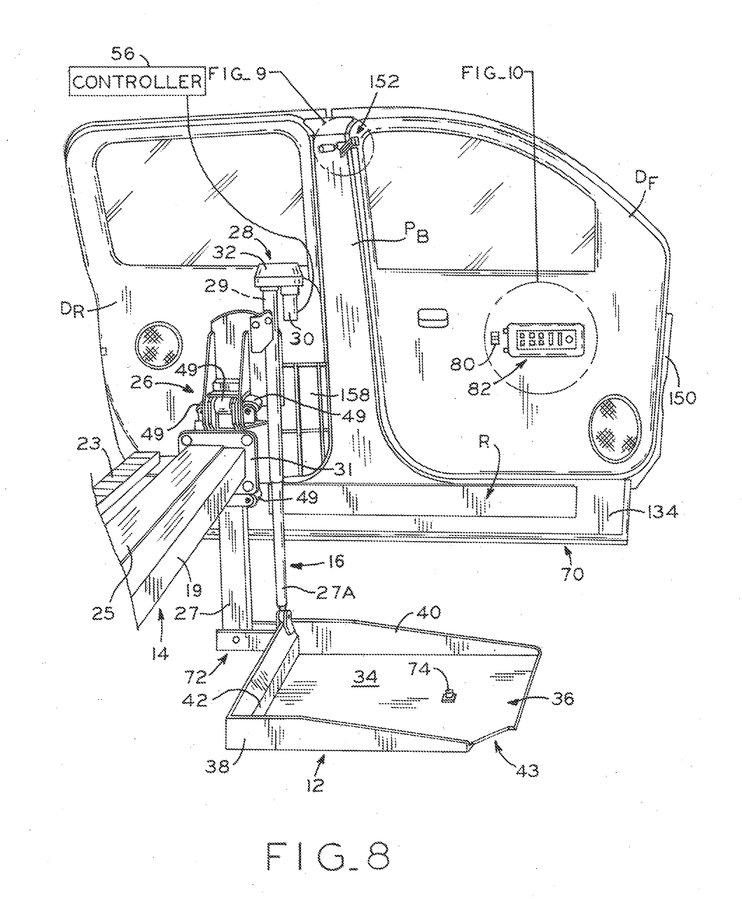

As discussed in sections 1 and 2, wheelchair lift 10 is designed for minimal impedance into the cabin space of vehicle V, such that little or no loss of vehicle occupancy results from the installation of lift 10. A method for installing wheelchair lift 10 is also provided in section 3. The method modifies an otherwise “factory stock” passenger vehicle to provide additional vertical space within the cabin of vehicle V. This additional vertical space accommodates lift 10 and facilitates the compatibility of vehicle V with large wheelchairs and/or tall vehicle occupants. Front and rear vehicle doors D_{F}, D_{R} are hingedly fixed to a reinforced pillar assembly 70 (FIG. 8), which in turn is mounted to lift 10. Thus, doors D_{F}, D_{R} may be moved laterally away from the vehicle as a single unit, thereby creating a large, unimpeded access opening O (FIG. 3) large enough for a wheelchair and wheelchair user, as well as vehicle passengers and cargo. The finished combination of vehicle V and wheelchair lift 10 provides a vehicle having an undiminished appearance and functionality compared to a factory stock vehicle, but that is also able to accommodate even a large wheelchair with a tall user.

For purposes of the present disclosure, vehicle V is considered to have a “front,” “rear,” “passenger side” and “driver side” in accordance with United States convention. Referring generally to FIGS. 1 and 2, doors D_{F}, D_{R} are shown on the driver's side, with wheelchair support platform 12 opening toward the front as shown, e.g., in FIG. 6. A longitudinal axis of vehicle V extends from front to rear and is generally equidistant from the passer and driver sides of vehicle V. The “lateral” direction is defined as a direction generally transverse or perpendicular to the longitudinal axis and generally toward or away from the driver or passenger sides.

A structure comparatively closer to the longitudinal axis of vehicle V is considered to be “inside” or “inner” compared to a structure comparatively farther away from the longitudinal axis. Conversely, the farther structure may be said to be “outside” or “outer” compared to the closer structure. Thus, for example, doors D_{F}, D_{R} are positioned laterally outwardly of, e.g., vertical actuator 16 (FIG. 6).

Although lift 10 is shown and discussed as being installed on the driver side of vehicle V, it is contemplated that the passenger side is equally amenable to use of lift mechanism 10, or that lift mechanism 10 may be installed on both driver and passenger sides of vehicle V.

### 1. Wheelchair Lift Mechanism

As best seen in FIG. 6, wheelchair lift 10 includes wheelchair support platform 12, lateral actuator assembly 14 and vertical actuator assembly 16. Wheelchair support platform 12 is attached to vertical actuator assembly 16 and moves up or down along a generally vertical path upon actuation of vertical actuator 16. Lateral actuator 14 is fixed directly to the floor on the inside of a vehicle cabin, as described below. Vertical actuator 16 is attached to a movable end of lateral actuator assembly 14, such that vertical actuator assembly 16 is moved side to side (i.e., laterally) when lateral actuator assembly 14 is activated. When a person seated in a wheelchair is supported on wheelchair support platform 12, vertical actuator assembly 16 raises or lowers the person and wheelchair between ground level G and the level of lowered floor 64 of vehicle V, as shown in FIG. 6. When vertical actuator assembly 16 is in the raised position, the bottom surface of wheelchair support platform 12 is at or above the level of floor 64 of vehicle V, enabling lateral actuator assembly 14 to translate the person and wheelchair into and out of of the cabin of vehicle V via opening O.

As shown in FIG. 4, lateral actuator assembly 14 includes actuator housing 18 and a single actuator arm 19 slidably received within housing 18. In an exemplary embodiment, housing 18 is a box-shaped frame including an outer set of four rollers 46 rotatably received within an outer roller subframe 48 (FIG. 5) and a corresponding inner set of rollers 46 rotatably received within an inner subframe 48 (FIG. 4). The inner and outer subframes 48 are joined by frame supports 51, as shown in FIG. 4. One or more auxiliary frame supports 49A extending diagonally between neighboring pairs of frame supports 51 may be used for torsional strength and rigidity of the overall housing 18. In an exemplary embodiment, subframes 48 may be spaced apart by any amount sufficient to provide the strength necessary to support the cantilevered load of vertical actuator 16, platform 12 and the user seated thereupon (FIG. 6), as further described below.

Arm 19 is formed as a tube having a square cross section sized to fit within the space between rollers 46, as shown in FIG. 5, and includes slider bearing 25 along a top surface thereof to provide a smooth interface with the inner upper roller 46, which is the roller subject to the greatest stress when a user of lift 10 is supported on platform 12. In an exemplary embodiment, slider bearing 25 and inner upper roller 46 define a relatively high-friction interface to avoid sliding and ensure rolling contact as arm 19 moves. The lower roller 46 of the outer subframe 48 (FIG. 5) may be provided with a longer axial length to handle the larger stresses it encounters. Similarly, at the inner subframe 48, the upper roller 46 may have a longer axial length for the same reason. It is contemplated that housing 18 and arm 19 may take a variety of forms within the scope of the present disclosure, such as cylinder-in-cylinder arrangements, I-beam- and roller arrangements, plates slidably coupled to one another, and the like. Moreover, housing 18 may be any structure adapted to cooperate with arm 19 to constrain arm 19 to sliding motion with respect to housing 18.

Actuator arm 19 is moveable between a retracted position (in which vehicle V has doors D_{F}, D_{R} positioned as shown in FIG. 1) and an extended position (in which vehicle V has doors D_{F}, D_{R} positioned as shown in FIG. 3). The motive force for movement of actuator arm 19 is provided by actuator drive 20, which includes lead or ball screw 21 received in actuator tube 17 and drivingly secured to a lead- or ball-screw bushing (not shown) fixed to arm 19. When motor 22 is activated, transmission 24 transmits power from motor 22 to lead screw 21, rotating lead screw 21 to laterally advance or retract arm 19. Alternative linear actuation devices may be utilized in lateral actuator 14, such as a hydraulic cylinder, a pneumatic actuator, a rack-and-pinion arrangement, or the like. Arm 19, shown as a single arm extending from housing 18, may alternatively use multiple arms extending from one another in a well-known “telescoping” type arrangement.

Additional detail regarding the retracted and extended configurations of lift mechanism 10, and the process of toggling therebetween, can be found in U.S. Patent Application Publication No. 2011/0070057, filed Sep. 22, 2010 and entitled “Vehicle Wheelchair Lift”, the entire disclosure of which is hereby expressly incorporated herein by reference for all that it teaches and for all purposes.

Vertical actuator assembly 16 (FIGS. 6 and 8) is constructed similarly to lateral actuator assembly 14, except that vertical actuator housing 26 (FIG. 8) is oriented substantially perpendicularly to lateral actuator housing 18. As shown in FIG. 8, vertical actuator housing 26 slidingly receives vertical arm 27 via two sets of four rollers 49, similar to horizontal actuator 14. However, a separate drive arm 27A is located outside arm 27 and linked via platform pivot mechanism 72, the structure and function of which is further discussed below. When vertical actuator drive 28 is activated, drive arm 27A extends and retracts to lower and lift vertical actuator arm 27 and platform 12. Vertical actuator drive 28 includes vertical lead or ball screw 29 coupled to drive arm 27A via a lead- or ball-screw bushing (not shown), with lead screw 29 driven by vertical actuator motor 30 through vertical actuator transmission 32.

In an exemplary embodiment, vertical actuator assembly 16 is substantially the same as lateral actuator assembly 14, with different lengths of extension and retraction as necessary for adaptation to a particular vehicle. As noted above with respect to lateral actuator assembly 14, it is contemplated that lateral actuator assembly 14 and/or vertical actuator assembly 16 may be any known system capable of moving wheelchair support platform 12 laterally or vertically, respectively, between the inside of the vehicle cabin and the ground. It is also contemplated that lateral and vertical actuator assemblies 14, 16 may be angled somewhat with respect to the vertical and horizontal directions (and with respect to one another) while still being considered “vertical” and “horizontal” for purposes of the present disclosure.

Lateral actuator assembly 14 is coupled to vertical actuator assembly 16 via coupling flange 31 (FIG. 8). More particularly, lateral actuator arm 19 is coupled to housing 26 so that lateral actuator drive 20 advances vertical actuator assembly 16 and support platform 12 laterally toward or away from vehicle V (as discussed below).

Referring to FIGS. 4 and 8, an “energy chain” or wire carrier 23 may be attached to the rear portion of lateral actuator assembly to carry a wire bundle, which may include wires from the vehicle power source (not shown) to vertical actuator motor 30 and various sensors and switches as may be required for particular implementations. In addition to wires specially added for control of wheelchair lift 10, wire carrier 23 may also include rerouted wires originally installed in vehicle V, such as wires for the vehicle function switches (e.g., window and lock control switches) provided on control panel 82, as well as actuator override switch 80 (shown in FIG. 10 and described further below).

Wheelchair support platform 12 includes an upwardly-facing support surface 34, shown in FIG. 8, that is bounded around a portion of its perimeter by inside wall 38, outside wall 40 and rear stop wall 42, with open side 36 at the front of platform 12. Inboard and outboard walls 38, 40 help to guide a wheelchair onto support platform 12 and to aid in maintaining the wheelchair on support surface 34. Rear wall 42 limits the rearward motion of the wheelchair, thereby preventing the wheelchair from falling or rolling off the back of support platform 12. A locking structure (not shown) may also be supplied to lock the wheelchair to support surface 34 to prevent forward rolling once the wheelchair is fully received on support surface 34. The wheelchair locking structure may take any suitable form, such as a moveable barrier along open side 36, for example. Support surface 34 and inside wall 38 may optionally include cutout 43 sized and shaped to accommodate drive train components within the cabin of vehicle V, such as a 4-wheel drive transfer case as discussed in detail below.

As noted above, and with reference to FIG. 8, drive arm 27A and vertical arm 27 of vertical actuator assembly 16 are linked at their lower ends by platform pivot mechanism 72, which in turn is fixed to and forms a part of wheelchair support platform 12 (i.e., platform pivot mechanism 72 forms a framework which is part of a common weldment with wheelchair support platform 12 and its associated structures).

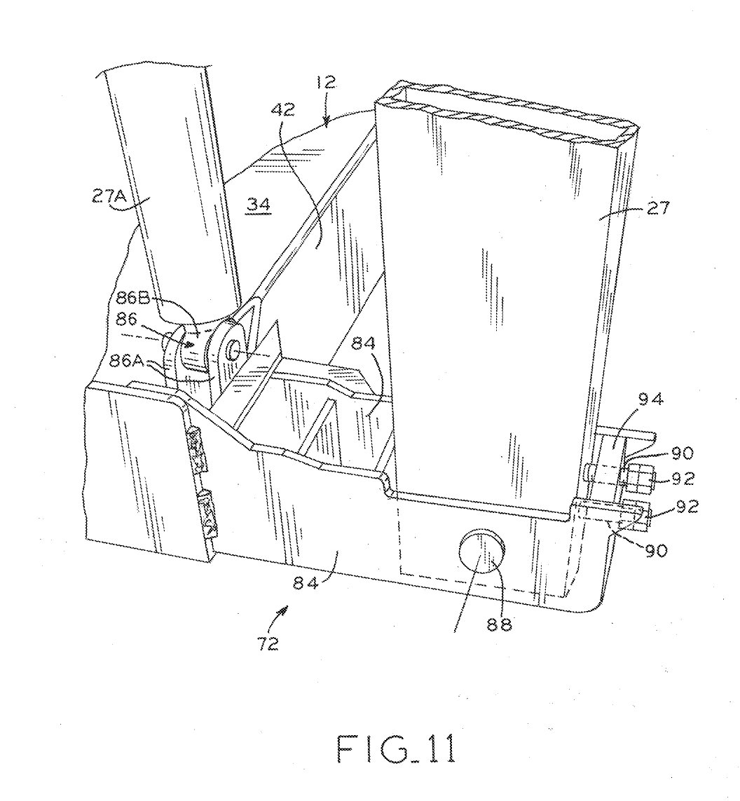

Referring to FIG. 11, pivot mechanism 72 includes a pair of extensions 84 positioned aft of attachment point 86 between drive arm 27A and wheelchair support platform 12. In the illustrated embodiment, attachment point 86 is approximately aligned in the forward/aft direction with rear wall 42 of support platform 12. Attachment point 86 allows some freedom of motion of wheelchair support platform 12 with respect to drive arm 27A, such as by the use of a spherical bushing functionally interposed between attachment brackets 86A and clevis 86B.

Aft of attachment point 86, vertical arm 27 attaches to arm extensions 84 pivotably via pivot pin 88. In addition, vertical arm 27 includes a pair of threaded studs 90 extending rearward therefrom, as shown in FIG. 11, with studs 90 affixed to the material of vertical arm 27 by, e.g., welding. Studs 90 extend through apertures formed in stop plate 94, with apertures 94 sized to allow studs 90 to freely move relative to stop plate 94. Stop plate 94 spans the lateral distance between arm extensions 84 and is fixed thereto, e.g., by welding. Stop nuts 92 are threaded onto studs 90, with a gap left between the forward face of the stop nut and the rear face of the stop plate, as illustrated.

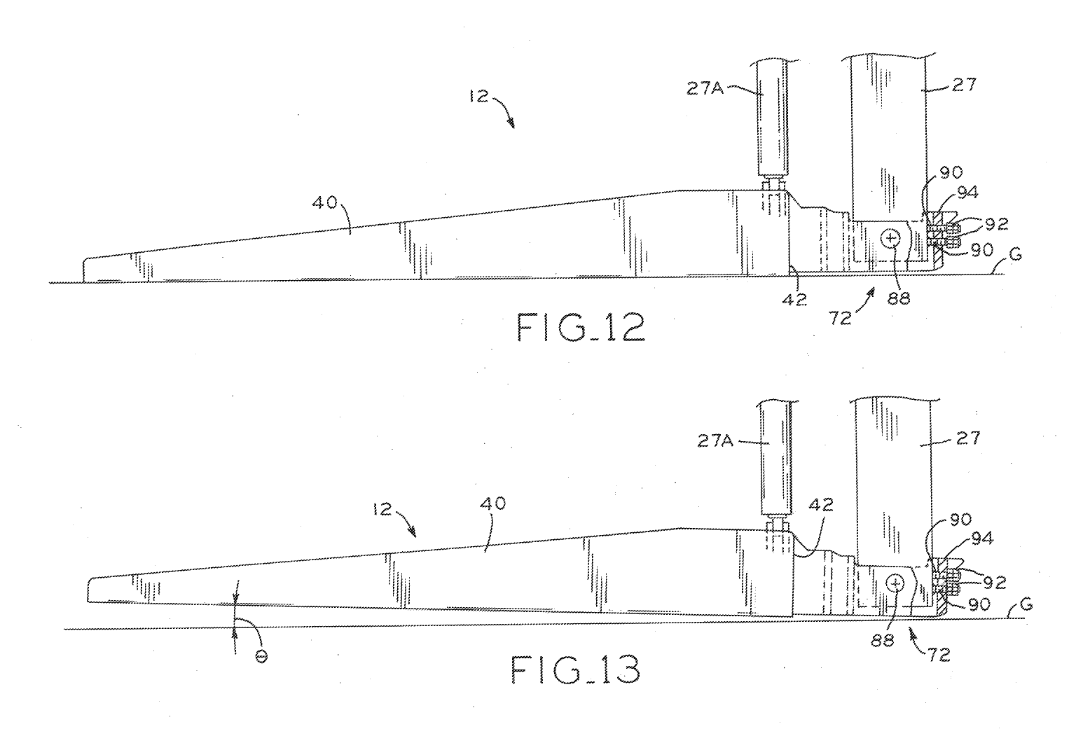

When vertical actuator 16 is activated to raise platform 12 from its lowered position adjacent to ground G (FIGS. 3 and 12), vertical arm 27 temporarily remains in its fully lowered position while the gap between stop nuts 92 and stop plate 94 closes. As shown in FIG. 13, wheelchair support platform 12 pivots about pivot pin 88 during the initial stage of the lifting procedure, with the pivoting motion giving rise to slant angle θ before the entire wheelchair support platform 12 lifts away from ground G. Once the gap between stop nut 92 and stop plate 94 closes, further pivoting about pivot pin 88 is prevented by the abutment of nut 92 on plate 94. At this point, further upward advancement of drive arm 27A also lifts vertical arm 27 and support platform 12. During this vertical lifting, slant angle θ is preserved.

The magnitude of slant angle θ is a function of the size of the gap between stop nuts 92 and stop plate 94 when support platform 12 is level upon ground G (FIG. 12). If an increase or decrease in slant angle θ is desired, the initial gap between stop nuts 92 and stop plate 94 may be increased or decreased, respectively. Advantageously, slant angle θ can be used to compensate for varying amounts of material deflection arising from the weights of various wheelchairs and wheelchair users, thereby ensuring that wheelchair support platform 12 will be level or slightly slanted toward the rear of the vehicle V as the user is lifted toward opening O during an ingress procedure (further described below). The downward tilt of platform 12 through slant angle θ at the bottom of its vertical movement also ensures that the forward lip of platform 12 (i.e., at opening 36) will be allowed to sit flush with the adjacent ground surface to facilitate rolling of wheelchairs on and off platform 12.

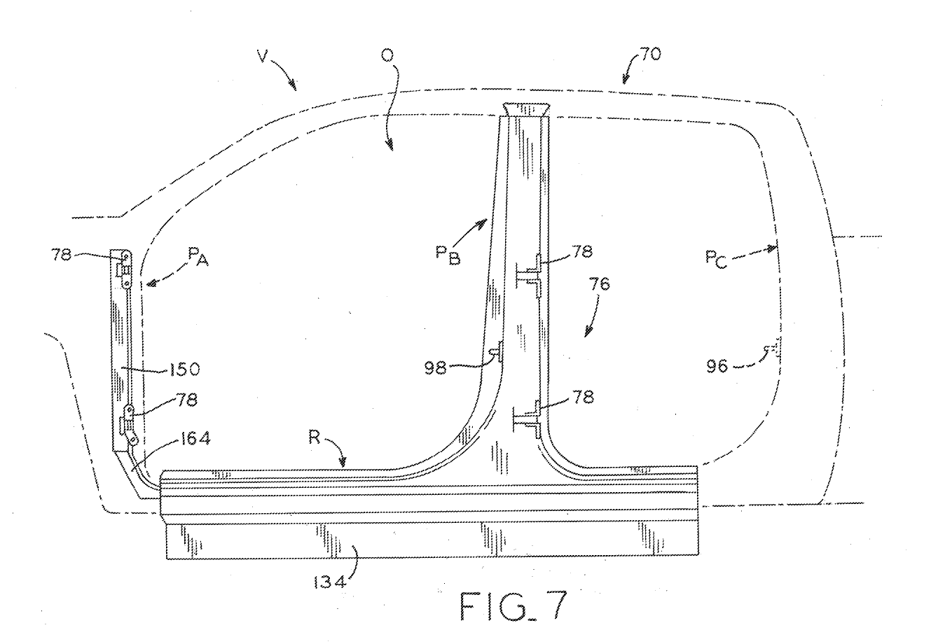

Turning again to FIG. 3, lateral actuator assembly 14 is mounted to vehicle body B within the cabin of a vehicle V. In the illustrated embodiment, lateral actuator assembly 14 is mounted to the original floor of vehicle body B, generally behind the vehicle operator. Advantageously, and as best seen in FIG. 7, lateral actuator assembly 14 fits underneath factory-standard rear passenger seats, such that little or no passenger space is sacrificed by the installation of lift mechanism 10 within the cabin of vehicle V. Thus, the seating capacity of vehicle V is substantially undiminished as compared to a comparable unmodified vehicle.

As best seen in FIGS. 3 and 4, and as also discussed in detail below with respect to a method of installation for wheelchair lift 10, a lowered floor assembly 64 is installed at the lift-side area of the vehicle (shown as the driver's side). The lowered floor 64 increases total vertical space available to the wheelchair within the cabin of vehicle V, which aids in accommodating large wheelchairs and/or tall operators. Additional support, such as reinforcement plates, may be installed under driver's side floor 64 for extra support of vehicle body B and to enhance rigidity of the vehicle and lift-related components surrounding enlarged driver access opening O. In an exemplary embodiment, vehicle body B is raised from the vehicle frame to accommodate the lowered floor without compromising vehicle ground clearances. Further discussion of lowered floor 64 and its associated structures is described in U.S. Patent Application Publication No. 2011/0070057, filed Sep. 22, 2010 and entitled “Vehicle Wheelchair Lift”, the entire disclosure of which is hereby expressly incorporated herein by reference for all that it teaches and for all purposes.

In the closed position, vehicle doors D_{F}, D_{R} move laterally together with vertical actuator 16 and wheelchair support platform 12 (together with any vehicle operator received thereon) when lateral actuator assembly 14 is activated, thereby exposing a large opening O in the side of vehicle V which is suitable for entry and exit of even a large wheelchair and/or tall wheelchair user.

In some instances, it may be desirable for a user of vehicle V to enter or exit the vehicle cabin without utilizing actuator assemblies 14, 16, but instead by manually operating doors D_{F}, D_{R} in the manner of a conventional, unmodified vehicle. For example, vehicle V may be used by wheelchair users and non-wheelchair users alike. When the wheelchair user is using vehicle V, ingress and egress is achieved by the use of wheelchair lift 10, as described in detail herein. However, the non-wheelchair user may not wish to undergo the procedure of ingress and egress by wheelchair lift 10, but instead enter and exit by simply manually opening and closing front door D_{F}.

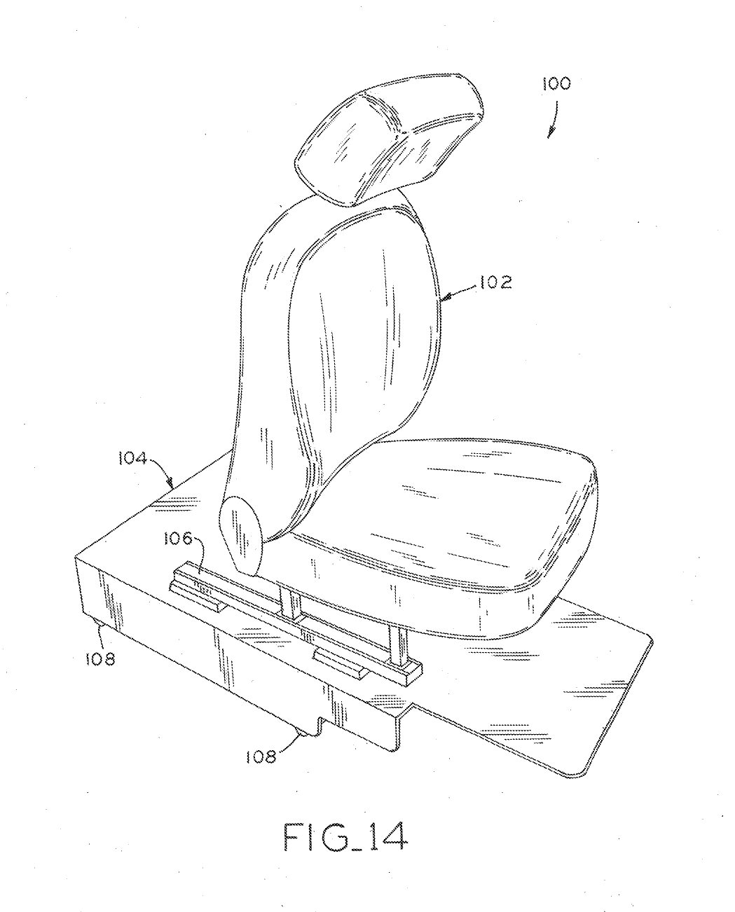

To this end, vehicle V may be provided with a non-wheelchair seat assembly 100, as shown in FIG. 14. Seat assembly 100 includes a standard driver or passenger seat 102 mounted to compatibility platform 104 via adjustment rails 106. Compatibility platform 104 may include rollers 108, such that seat assembly 100 may be rolled backwardly onto wheelchair support platform 12 in a similar manner to a wheelchair. Seat assembly 100 may include a locking mechanism (not shown) designed and positioned to interface with one or more stop pins 74 (FIG. 3) to lock wheelchair seat assembly 100 to platform 12. With wheelchair lift 10 in the fully retracted position and non-wheelchair seat assembly 100 received within the cabin of vehicle V, vehicle V may be driven by a non-wheelchair user in a traditional manner. When vehicle V is being used in this way, front door D_{F} may be manually opened and closed without actuation of lift assembly 10 by simply unlatching door D_{F} from factory provided latch 98 (FIG. 7) in a traditional manner, and pivoting door D_{F} open about hinge bar 150, also in a traditional manner. Rear door D_{R} may also be manually opened in a similar fashion, such as for service or inspection of portions of wheelchair lift 10, including vertical actuator assembly 16 which mounts adjacent the inside of door D_{R} (as shown in FIG. 8).

Manual operability of front and rear doors D_{F}, D_{R} also confers a safety benefit on vehicle V by allowing egress of vehicle occupants without the need for vehicle power (e.g., electrical power) to activate horizontal and vertical actuators 14 and 16. For example, in the case of an accident involving vehicle V, the vehicle occupants or emergency personnel may simply manually open door D_{F} and/or D_{R} to extract occupants from within the vehicle cabin without any need for actuation of lift assembly 10.

Doors D_{F}, D_{R} are shown mounted to reinforced pillar assembly 70 in FIG. 8. As further described below in section 3, pillar assembly 70 includes “B” pillar P_{B} and lower rail R which form a unitary structure removed from a stock vehicle V during the modification thereof to include wheelchair lift 10. Further reinforcement plates are provided along rail R, as required or desired for a particular application, including reinforcement door skirt 134 in the illustrated embodiment. As shown in FIG. 7, stock door hinges 78 attached to “B” pillar P_{B} are preserved in their “stock” or unmodified arrangement, and form the hinged attachment for rear door D_{R}. In addition, hinge bar 150 is designed to mate with a corresponding surface of the unmodified vehicle, and is welded to reinforced pillar assembly 70 as shown in FIG. 7 and further described below, thereby preserving the factory locations for front-door hinges 78 which interface with front door D_{F} for hinged attachment to pillar assembly 70. In addition, the factory provided latch 98 for front door D_{F} is preserved on “B” pillar P_{B} to further preserve the unmodified spatial interaction between front door D_{F} and the adjacent structures of vehicle V during manual opening and closing of door D_{F}.

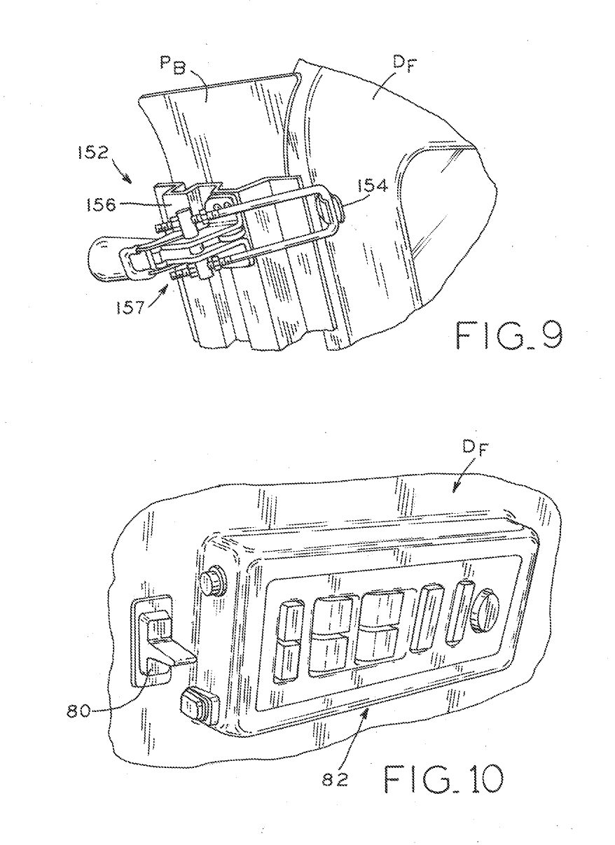

Referring again to FIG. 8, door clamp 152 may be provided in some instances to augment the robustness of the attachment between front door D_{F} and “B” pillar P_{B}. As shown in FIG. 9, door clamp 152 includes a latch 154 fixed to door D_{F}, and a base 156 attached to “B” pillar P_{B} (though, of course, this arrangement may be reversed). A camming mechanism 157 can be actuated to draw latch 154 toward base 156, snugly seating door D_{F} against pillar P_{B} in a standard “over-center” lock arrangement. For applications where hinge bar 150 may slightly flex with respect to the remainder of reinforced pillar assembly 70, door clamp 152 may be used to further augment and ensure proper alignment of front door D_{F} with respect to “B” pillar P_{B}.

In addition to providing a proper interface for the hinged attachment of front and rear doors D_{F} and D_{R}, reinforced pillar assembly 70 provides the attachment point of doors D_{F}, D_{R} to wheelchair lift 10. For example, mounting plate 158 may be provided to interface with “B” pillar P_{B}, rail R, reinforcing skirt 134, and any other adjacent frame structures in order to provide a large area (and therefore, low stress) mounting area to support the weight of doors D_{F}, D_{R} rigidly at the outer end of arm 19 of lateral actuator assembly 14.

Referring now to FIG. 6, further provision may be made to ensure proper alignment of doors D_{F}, D_{R} with the adjacent periphery of opening O when wheelchair lift 10 is configured in its fully retracted position (i.e., with doors D_{F}, D_{R} fully closed as shown in FIG. 1). First, hinge bar 150 is designed to interface with the unmodified A-pillar P_{A} of vehicle V. Specifically, hinge bar 150 is shaped and sized to interface with the adjacent surface of the A-pillar P_{A} of body B (i.e., the forwardmost pillar which is home to hinges 78 before modification) when doors D_{F}, D_{R} are fully closed, such that the abutting surfaces of hinge bar 50 and A-pillar P_{A} facilitate proper door alignment. Hinge bar 150 also provides structural support for opening and closing of front door D_{F} as a part of reinforced pillar assembly 70 (FIG. 7), particularly when doors D_{F}, D_{R} are spaced laterally away from opening O (FIG. 6).

Hinge bar 150 also includes an angled alignment bracket 160 affixed thereto (e.g., by welding). Bracket 160 is positioned to interface with a correspondingly sized alignment bracket 162 adjustably mounted to vehicle body B (e.g., by bolts received through elongated slots as shown in FIG. 6). When doors D_{F}, D_{R} are closed by actuation of lateral actuator assembly 14, a lower surface of alignment bracket 160 engages the upper surface of the angled portion of alignment bracket 162 to lift doors D_{F}, D_{R} to their proper orientation prior to seating against the periphery of opening O. Thus, to the extent that doors D_{F}, D_{R} may sag or “droop” slightly due to material deformations arising from the variable weight of wheelchairs and wheelchairs users, alignment brackets 160, 162 cooperate to convert some of the lateral force provided by lateral actuator 14 into upward force on doors D_{F}, D_{R} just prior to complete retraction of lateral actuator 14.

At the rear side of the door assembly shown in FIG. 8, alignment upon closing is provided by the “stock” rear door latch 96 (FIG. 7), which is left in its stock location on “C” pillar P_{C} during modifications of vehicle V, and the corresponding latch structure (not shown) on rear door D_{R}.

### 2. Wheelchair Lift Mechanism Use and Operation

A vehicle operator with a wheelchair accesses vehicle V by actuating lateral and vertical actuator assemblies 14, 16 to move wheelchair support platform 12 from an inside position (FIG. 1) to an outside position (FIG. 3). In the inside position with doors D_{F}, D_{R} closed, as shown in FIG. 1, platform 12 rests upon lowered floor 64 (via platform ramp 120, FIG. 3). In the outside position, platform 12 is planted firmly on ground G next to vehicle V, as shown in FIG. 3.

Controller 56 is connected to motors 22, 30 to control actuator assemblies 14, 16, respectively, according to inputs or commands issued by the operator and subject to the status of one or more safety switches and safety override switch 80 (FIGS. 8 and 10). In use, the operator issues an “open door” signal or command to controller 56, such as by using a remote control or a switch mounted to switch panel 82 mounted on or in vehicle V, to execute an ingress routine programmed in controller 56 to open doors D_{F}, D_{R} via actuator assemblies 14, 16 to the configuration of FIG. 3.

Controller 56 initiates the ingress routine by activating lateral actuator motor 22 to extend actuator arm 19 outwardly, which simultaneously unseats doors D_{F}, D_{R} from opening O. The initiation of this part of the routine is also used for egress, as noted below, and is subject to certain safety considerations taken into account by controller 56 via one or more sensors. For example, controller 56 may avoid activating motor 22 if the transmission of vehicle V is in any state other than “park,” if vehicle V is moving, or if the user of vehicle V is belted in to the cabin. If a sensor is malfunctioning or the user needs to override these sensor functions for any reason, override switch 80 is provided. When override switch is activated, controller 56 will allow the user to command the initiation of the ingress or egress routine regardless of the sensor inputs that would normally prevent such initiation.

Once lateral actuator assembly 14 has moved wheelchair support platform 12 sufficiently far to allow inboard wall 38 to clear the outermost portion of lowered floor 64, controller 56 receives a signal from a switch or sensor near lateral actuator 14 (such as a limit switch or proximity switch, for example). In response to this signal, controller 56 deactivates lateral actuator motor 22 and activates vertical actuator motor 30 to lower wheelchair support platform 12 from the level of lowered floor 64 to the level of ground G near vehicle V. Controller 56 deactivates motor 30 when it receives a signal indicating that platform 12 has reached ground G, such as through a limit switch.

With support platform 12 securely on the ground, the operator may wheel his or her wheelchair onto support surface 34 via open end 36. In the embodiment illustrated in FIGS. 4 and 5, the operator will wheel his or her wheelchair onto wheelchair support platform 12 backwards until the wheelchair is fully received on platform 12 the forward most portion of the wheelchair is aft of open end 36. A locking mechanism (not shown) may be provided to lock any of various makes and models of wheelchair to platform 12, such that the wheelchair is immovable with respect to platform 12 once rolled to the correct position and locked in place.

The operator then issues a “close door” signal or command to controller 56, such as via a remote or a switch on control panel 82 (FIGS. 8 and 10), which initiates a second sequence of the ingress routine. Upon receiving the “close door” command, controller 56 activates motor 30 to raise vertical actuator arm 27 back toward its retracted position.

As with the lowered position, a limit switch or other sensor may be positioned to send a signal to controller 56 indicating that vertical actuator 16 has reached the raised position. With the vertical actuator assembly 16 in such raised position, the bottom face of wheelchair support platform 12 is raised high enough to clear the upper surface of floor 64. In this position, wheelchair support platform 12, vertical actuator assembly 16 and the operator and wheelchair are ready to be received through opening O and into the cabin of vehicle V. In response to this “platform raised” signal, controller 56 deactivates vertical actuator motor 30 and activates lateral actuator motor 22 to draw lateral actuator arm 19 to a retracted position. The retracted position is again indicated by a switch or sensor signal within housing 18, which prompts controller 56 to deactivate lateral actuator motor 30. When lateral actuator assembly 14 is in the retracted position, doors D_{F}, D_{R} are received within the corresponding opening O and seated against the frame of vehicle V.

The operator can exit vehicle V by initiating an “egress” routine of controller 56 in a similar manner. The egress routine operates as the reverse of the ingress routine.

### 3. Manufacture/Installation of the Wheelchair Lift Mechanism

As noted above, vehicle V is prepared to receive wheelchair lift 10 by raising vehicle body B with respect to the vehicle chassis or frame, and lowering the floor of vehicle body B in the area where support platform 12 of wheelchair lift 10 is to be located when wheelchair lift 10 is in the raised and retracted configuration. In the illustrated embodiment, a pickup truck is the subject of the vehicle modifications described herein. Pickup trucks have the advantage of being easily modifiable in the manner described below, while also having interior dimensions (i.e., cabin height and rear seat position) which accommodate wheelchair lift 10 and a wide variety of wheelchairs and wheelchair users.

However, it is contemplated that other vehicles may be used in accordance with the present disclosure. Any vehicle combining a) sufficient space behind the front row seats (i.e., driver and front passenger seats) with either b) a vehicle frame and body adaptable to the lifting and floor modification as discussed herein or c) a sufficiently tall interior space to obviate the need for additional vertical clearance within the cabin, is a candidate for installation of wheelchair lift mechanism 10. For example, it is contemplated that, in addition to pickup trucks as described herein, sport utility vehicles and other suitably sized vehicles may be used. Further, while the present disclosure is directed to an installation method and system for “body-on-frame” vehicles such as trucks and larger sport-utility vehicles, it is also contemplated that the present disclosure may be adapted to “unibody” type vehicles such as cars, wagons and smaller sport utility vehicles.

Prior to beginning modification of vehicle V to accept wheelchair lift 10, the interior seats and upholstery may be removed from the vehicle cabin to protect the aesthetics and integrity of the fabric or other covering material thereof. In an exemplary embodiment, a lift kit may then installed between the frame and body B to provide additional vertical clearance for subsequent modifications. Such a lift kit may be installed in accordance with conventional methods, e.g., vehicle body B is disconnected from the vehicle frame, a spacer is installed between the frame and body B, and the frame and body B are reconnected. In this way, vehicle body B is reinstalled to the vehicle frame in a raised or lifted position relative to the original position of vehicle body B. In one exemplary embodiment, the raised position may be about 3 inches higher than the original position, which is a standard vehicle lift commonly applied to pickup trucks.

The front and rear doors D_{F}, D_{R} are removed from vehicle body B and set aside for later assembly, as described below. Referring to FIG. 7, central or “B” pillar P_{B} is disposed between front and rear doors D_{F}, D_{R}, aft of the “A” pillar P_{A} forming the front edge of opening O and forward of the “C” pillar P_{C} at forming the rear edge of opening O. “B” pillar P_{B} is cut away from opening O in vehicle body B at this time, together with the lower rail R spanning “A” pillar P_{A} and “C” pillar P_{C}. Cutaway framing 76 is set aside for later integration into reinforce pillar assembly 70, which forms the central frame structure for attachment of doors D_{F}, D_{R} to lift mechanism 10 as further described below.

With opening O of vehicle body B now fully exposed, at least a portion of the preexisting floor of vehicle body B is removed. In an exemplary embodiment, this removal step is performed by cutting away substantially all of the floor material occupying the driver's and/or passenger's side of vehicle V in the front seating row area. Thus, the cutaway portion extends from opening O laterally inwardly as far as possible toward the lateral center of the vehicle cabin, such as to center console or drive train components, or extends inwardly to the center of the vehicle cabin itself where possible. For 4-wheel drive vehicles, the interior terminus of the cutout will typically be adjacent to drive train components near the center of the vehicle, such as the drive shaft or transfer case for the 4-wheel drive system. For 2-wheel drive vehicles, the cutout may extend further inwardly in the absence of 4-wheel drive system components.

At the forward edge, the cutouts may come to the footrest/pedal area, as shown in FIG. 3, to obviate the need for any modification of systems and/or wiring in the front dashboard area and around the standard vehicle control pedals. In some cases, standard vehicle pedals may be removed, although in many cases the pedals will be retained to preserve regular functionality of vehicle V for drivers who do not use a wheelchair.

Referring still to FIG. 3, the floor cutout may extend as far back as the mounting point for lateral actuator assembly 14, which is mounted to the preexisting floor of vehicle body B under the rear passenger seats, as discussed above. Advantageously, creating a maximum cutout area to receive wheelchair support platform 12 allows a large size platform 12 to be used, which therefore facilitates compatibility of vehicle V and wheelchair lift 10 with even the largest commercially available motorized wheelchairs. Of course, it is contemplated that a smaller cutout may be used as required or desired for a particular application.

With the floor cutout procedure complete, lowered floor assembly 64 (FIG. 3) may be installed into the cutaway space created by the floor cutout procedure. In an exemplary embodiment as best shown in FIG. 4, lowered floor 64 includes deck 110, rear and side walls 112, 114, and front step 116, which provides a transition between the stock vehicle floor near the control pedals and lowered floor 64. The components of floor assembly 64 are fixed to one another via any suitable method, such as welding.

Floor assembly 64 may further include platform ramp 120, which is contacted by support platform 12 as lateral actuator assembly 14 draws platform 12 into the cabin of vehicle V. Platform ramp 120 provides support surface 122, upon which wheelchair support platform 12 rests when inside the cabin of vehicle V. Ramp surface 124 ensures that wheelchair platform 12 will smoothly enter the cabin of vehicle V regardless of slight discrepancies in the height of support platform 12, which may occur due to varying amounts of weight supported by platform 12. In an exemplary embodiment, ramp surface 124 and support surface 122 have strips of low-friction material, such as UHMW, attached thereto to promote smooth movement of platform 12 over ramp 120. In addition to providing such smooth movement, ramp 120 also provides support for platform 12 when wheelchair lift 10 is in the raised and retracted position, thereby easing the load borne by actuator mechanisms 14, 16 during operation of vehicle V.

Lowered floor assembly 64 is installed on vehicle body B in place of the previously cut away floor. In an exemplary embodiment, back and side walls 112, 114 abut the cutaway edges and are welded thereto. Similarly, front step 116, if present, is welded to the abutting original floor material remaining on vehicle body B. With floor assembly 64 thus securely and sealingly mated to vehicle body B, further reinforcement structures may be added as required for strength and rigidity.

Wheelchair lift 10 may then be installed within the vehicle cabin. First, lateral actuator assembly 14 is mounted to the original floor of vehicle body B underneath the rear seat and aft of the operator area, as shown in FIGS. 3 and 4 and described above. Vertical actuator assembly 16 and wheelchair support platform 12 are fixed to lateral actuator assembly 14 as discussed above.

Turning now to FIG. 7, reinforced pillar assembly 70 is illustrated. As noted above, cutaway framing 76 is removed from vehicle V to expose opening O during the initial phases of the vehicle conversion. Advantageously, the use of cutaway framing 76 and reinforced pillar assembly 70 preserves factory stock hinges 78, latch 98 and rail R. However, in some applications cutaway framing 76 may lack the necessary mechanical strength to support the forces exerted on it when used in conjunction with wheelchair lift 10 as described herein. Moreover, pillar assembly 70 forms the central framing structure for attachment of doors D_{F}, D_{R} to lateral actuator 14, as described above with respect to FIG. 8.

Accordingly, reinforcements may be provided as needed for a particular application. In the illustrated application, door skirt 134 is provided as a solid plate of steel, which offers additional strength and rigidity along rail R as well as increases the vertical extent thereof to compensate for lowered floor 64 (as described above). In addition, reinforced pillar assembly 70 includes hinge bar 150, which is designed to interface with the unmodified vehicle V (as noted above, hinge bar 150 interfaces with the unmodified forward or “A” pillar P_{A} of vehicle V). Hinge link 164 is provided in reinforced pillar assembly 70, and is welded to rail R and/or door skirt 134 at a lower rear end, and to hinge bar 150 at an upper forward end, as illustrated. Hinge link 164 is sized and shaped to preserve the spatial orientation between front hinges 78 and factory latch 98, such that front door D_{F} can be pivoted opened and closed via front-door hinges 78 in the same manner as the unmodified vehicle V during manual operation as described above.

As shown in FIGS. 1, 3 and 7, door skirt 134 of an appropriate length may be affixed along the lower edge of cutaway framing 76. Door skirt 134 ensures complete coverage of the expanded vertical extent 140 (FIG. 8, discussed below) of opening O after the installation of lowered floor 64. Door skirt 134 may interface with lower seal 136 (FIG. 4 to prevent road spray from entering into the vehicle cabin along the lower edge of lowered floor 64. Moreover, a portion of the original door seal of vehicle V is removed when a portion of vehicle body B is cut away to make room for lowered floor 64. Lower seal 136 functions to replace the portion of the standard vehicle seal removed during such modifications.

Finally, doors D_{F}, D_{R} are reattached to their respective door hinges 78 of reinforced pillar assembly. In the illustrative embodiment of FIG. 8, reinforced pillar assembly 70 is fixed to housing 26, which in turn is fixed to the end of arm 19 of horizontal actuator 14 as noted above. Thus, doors D_{F}, D_{R} move laterally toward or away from vehicle body B with actuation of lateral actuator assembly 14, but do not move vertically with actuation of vertical actuator assembly 16 during raising/lowering procedures as described above.

It is contemplated that various steps in the above description may be performed in a different order. For example, vehicle body B may be lifted from the vehicle frame, and lift spacers installed, prior to cutting out portions of the original floor and installing lowered floor 64. Moreover, the individual steps of manufacturing vehicle V with wheelchair lift 10 may be performed in any suitable order as required or desired for a particular application.

### 4. Features and Benefits of the Wheelchair Lift Mechanism

Wheelchair lift 10 used in conjunction with vehicle V offers several advantages, features and benefits over known vehicle wheelchair lift systems. For example, attachment of doors D_{F}, D_{R} to wheelchair lift 10 minimizes the lateral clearance required for ingress and egress of the operator, because doors D_{F}, D_{R} need only move slightly farther than the width of wheelchair support platform 12. In the exemplary embodiment of FIGS. 3 and 6, for example, total lateral movement may be a little as about 22 inches or 26 inches, and as much as about 36 inches or 38 inches, or within any range defined by any of the foregoing values. In one particular exemplary embodiment, total lateral movement may be equal to about 32 inches, which provides adequate clearance for a wide range of wheelchair sizes while maintaining reasonable strength and structural rigidity demands on lateral actuator assembly 14. Further, with wheelchair lift 10 in the extended and lowered position (FIG. 3) an operator may navigate his or her wheelchair off of wheelchair support platform 12 by simply moving forward, with no rotation of wheelchair support platform 12 or turning of the wheelchair required.

The lateral clearance required by lift 10 is similar to the space required for the full swing of doors D_{F}, D_{R} upon manual opening, thereby allowing an operator to enter and exit a vehicle equipped with wheelchair lift 10 at locations accessible to conventional vehicles, such as parking spaces, garages and the like. Moreover, the manual operability of doors D_{F}, D_{R} allows vehicle V to be used interchangeably by both users of wheelchairs and non-wheelchair users. Thus, the spouse of a wheelchair user can use vehicle V (using non-wheelchair seat assembly 100, shown in FIG. 14) in substantially the same manner as an unmodified vehicle, entering and exiting through the front door D_{F}. As also noted above, the manual operability of doors D_{F}, D_{R} confers a safety advantage on vehicle V, as users can exit the vehicle cabin even when vehicle power is not available.

Wheelchair lift 10 is contained entirely within the cabin of vehicle V, and does not extend into the undercarriage space underneath the vehicle. Thus, components of wheelchair lift 10 are protected from environmental degradation or damage in harsh conditions outside the vehicle cabin. Further, pickup trucks and sport utility vehicles including 4-wheel drive systems are compatible with wheelchair lift 10, because the lift components do not extend downwardly into vehicle undercarriage space normally occupied by 4-wheel drive systems such as front differentials, drive train components, transfer cases and the like. This compatibility with 4-wheel drive equipped vehicles allows users of wheelchairs to enjoy the safety and mobility benefits of such vehicles, i.e., during inclement weather or on uneven terrain.

Lowered floor assembly 64 and the resulting expanded vertical clearance of opening O allows relatively large wheelchairs to fit the cabin of vehicle V with minimal changes to the appearance of same, with the raised vehicle body B and door skirt 134 being the only outwardly visible signs of wheelchair lift 10, as shown in FIG. 1. In the exemplary embodiment of wheelchair lift 10 shown and described herein, tall vehicle operators with even the largest commercially available motorized wheelchairs are easily accommodated in the cabin of the illustrated pickup truck.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A wheelchair-accessible vehicle having a vehicle body including a floor, a passenger side and a driver side, a vehicle cabin accessible by an opening formed in at least one of said passenger and driver sides, said vehicle comprising:
a powered wheelchair lift system comprising:
a lateral actuator having a lateral actuator arm laterally extendable with respect to said vehicle body, said lateral actuator arm moveable between an extended position and a retracted position;
a vertical actuator coupled to said lateral actuator arm, said vertical actuator having a vertical actuator arm vertically moveable between a raised position and a lowered position; and
a wheelchair support coupled to said vertical actuator arm, said wheelchair support positioned inside said vehicle when said lateral actuator arm is in said retracted position and said vertical actuator arm is in said raised position, and said wheelchair support positioned outside said vehicle when said lateral actuator arm is in said extended position and said vertical actuator arm is in said lowered position; and
a door assembly comprising:
a pillar assembly fixed to said lateral actuator arm; and
a door hinged to said pillar assembly and pivotable between an open position and a closed position;
said pillar assembly and said door laterally separable from said vehicle body when said lateral actuator is moved from said extended position to said retracted position; and
said door manually pivotable between said open position and said closed position without actuation of said powered wheelchair lift system.

2. The wheelchair-accessible vehicle of claim 1, wherein said lateral actuator comprises:
a lateral actuator housing fixed to said floor of said vehicle, said lateral actuator housing comprising a pair of subframes laterally spaced from one another and joined by at least one frame support, each said subframe comprising a plurality of rollers pivotably mounted therein;
said lateral actuator arm received within said pair of subframes and engaging said plurality of rollers such that said lateral actuator arm is slidable through said lateral actuator housing; and
said lateral actuator coupled to said lateral actuator arm and operable to drive said lateral actuator arm between said extended position and said retracted position.

3. The wheelchair-accessible vehicle of claim 1, wherein said vertical actuator comprises:
a vertical actuator housing fixed to an outward end of said lateral actuator arm and comprising a plurality of rollers pivotably mounted therein;
said vertical actuator arm received within said vertical actuator housing and engaging said plurality of rollers thereof, such that said vertical actuator arm is slidable through said vertical actuator housing; and
said vertical actuator coupled to said vertical actuator arm and operable to drive said vertical actuator arm between said raised position and said lowered position.

4. The wheelchair-accessible vehicle of claim 3, wherein said vertical actuator is coupled to said vertical actuator arm via a platform pivot mechanism comprising:
at least one arm extension fixed to said a rear portion of said wheelchair support;
an actuator attachment point fixed at a forward end of said arm extension such that said wheelchair support is slantable with respect to said vertical actuator arm;
a pivot pin pivotably coupling said vertical actuator arm to said arm extension at a point aft of said actuator attachment point, such that upward lift of said actuator slants said wheelchair support rearward as said wheelchair support pivots about said pivot pin; and
a pivot stop positioned to engage said vertical actuator arm when a predetermined amount of slant is achieved.

5. The wheelchair-accessible vehicle of claim 4, wherein said pivot stop comprises:
at least one threaded rod fixed to said vertical actuator arm;
a stop plate fixed to said arm extension and having an aperture formed therethrough, said at least one threaded rod extending through said aperture and moveable relative to said stop plate; and
a stop nut coupled to said at least one threaded rod to define a gap between said stop nut and said stop plate when said wheelchair support is level, said gap closed when said wheelchair support reaches said predetermined amount of slant.

6. The wheelchair-accessible vehicle of claim 1, further comprising a non-wheelchair seat assembly attachable to said wheelchair support, whereby a non-wheelchair user may use said vehicle with entry and exit via said manual pivoting of said door.

7. The wheelchair-accessible vehicle of claim 1, wherein said pillar assembly comprises:
a cutaway framing portion of said vehicle comprising:
a central pillar having a front door latch mounted thereto, said door operable to cooperate with said front door latch to latch in a closed position; and
a rail extending forwardly and aft from said central pillar; and
a front door hinge bar fixed to a forward end of said rail and having a front door hinge fixed thereto, said door hinged to said pillar assembly via said front door hinge.

8. The wheelchair-accessible vehicle of claim 7, wherein said front door hinge is fixed to said rail via a hinge link.

9. The wheelchair-accessible vehicle of claim 8, wherein said rail comprises at least one reinforcement structure.

10. The wheelchair-accessible vehicle of claim 7, wherein said central pillar has at least one rear door hinge mounted thereto, said vehicle further comprising a rear door hinged to said pillar assembly via said rear door hinge.

11. The wheelchair-accessible vehicle of claim 7, wherein said hinge bar has a first alignment bracket fixed thereto and positioned to engage a corresponding second alignment bracket fixed to the body of the vehicle, such that said first and second alignment brackets engage during retraction of said lateral actuator to lift said pillar assembly and said door into proper alignment with said opening of said vehicle.

12. The wheelchair-accessible vehicle of claim 1, wherein at least a portion of said vehicle body includes a lowered floor on at least one of said passenger side and said driver side, said lowered floor increasing a vertical clearance of said opening as compared to a stock vertical clearance defined by an unmodified floor of said vehicle body.

13. A method of modifying a vehicle to include a wheelchair lift, the method comprising:
removing a front door from front-door hinges mounted at a front pillar of a vehicle body of the vehicle;
removing a rear door from rear-door hinges mounted at a central pillar of the vehicle body;
removing the central pillar from the vehicle body;
mounting a lateral actuator inside the body, the lateral actuator positioned to extend laterally from the vehicle body;
mounting a vertical actuator to the lateral actuator such that the vertical actuator is extendable from inside the vehicle body to outside the vehicle body;
coupling the central pillar, front-door hinges and rear-door hinges to the lateral actuator; and
coupling a wheelchair tray to the vertical actuator such that the wheelchair tray is moveable between a lowered position adjacent the ground and a raised position adjacent a floor of the vehicle.

14. The method of claim 13, wherein said step of removing the central pillar includes removing a lower rail attached to and extending forward and aft of the central pillar, the method further comprising:
removing the front-door hinges;
fixing a hinge bar to the lower rail, the hinge bar sized and shaped such that an unmodified spatial arrangement between the front-door hinges and a front-door latch mechanism mounted to the central pillar is preserved.

15. The method of claim 14, further comprising attaching a reinforcing structure to the hinge bar.

16. The method of claim 15, further comprising affixing a hinge link to the reinforcing structure and the hinge bar to accomplish the step of fixing the hinge bar to the lower rail.

17. The method of claim 13, further comprising, after said step of coupling the central pillar, front-door hinges and rear-door hinges to the lateral actuator:
hingedly attaching the front door to the front-door hinges; and
hingedly attaching the rear door to the rear-door hinges.

18. The method of claim 13, further comprising interposing a mounting plate between the central pillar and the lateral actuator, the mounting plate sized to spread the area of load distribution and thereby lower stress on the central pillar.

19. The method of claim 14, further comprising:
attaching a first alignment bracket to the hinge bar; and
attaching a second alignment bracket to the vehicle body, such that the first and second alignment brackets are positioned to engage one another when the front door is closed using the lateral actuator to ensure proper vertical alignment of the front door with the vehicle body.

20. The method of claim 13, further comprising installing a door clamp by:
attaching a latch of the door clamp to one of the front door and the central pillar;
attaching a base of the door clamp to the other of the front door and the central pillar, such that the door clamp is actuatable to draw the latch toward the base to snugly seat the front door against the central pillar.
